(19) United States
(12) Patent Application Publication
(10) Pub. No.: US 2022/0146790 A1
(43) Pub. Date: May 12, 2022

(54) OPTICAL LENS ASSEMBLY, IMAGING MODULE, AND ELECTRONIC DEVICE

(71) Applicant: JIANGXI JINGCHAO OPTICAL CO., LTD., Nanchang (CN)

(72) Inventors: Hairong ZOU, Nanchang (CN); Binbin LIU, Nanchang (CN); Han XIE, Nanchang (CN)

(73) Assignee: JIANGXI JINGCHAO OPTICAL CO., LTD., Nanchang (CN)

(21) Appl. No.: 17/284,467

(22) PCT Filed: Oct. 11, 2019
(86) PCT No.: PCT/CN2019/110525

§ 371 Date: Apr. 11, 2021

(30) Foreign Application Priority Data
Oct. 11, 2018 (CN) 201811181696.7

(51) Int. Cl. G02B 13/00; G02B 9/62; H04N 5/225

(52) U.S. Cl. CPC G02B 13/0045; H04N 5/2252; G02B 9/62

(57) ABSTRACT

An optical lens group comprises, in order from the object-side to the image-side: a first lens having positive refractive power, a second lens having positive refractive power, a third lens having negative refractive power, a fourth lens having negative refractive power, a fifth lens having positive refractive power, and a sixth lens having negative refractive power. The object-side surface of the first lens is concave at the perimeter of said lens, the image-side surface of said lens is convex at the perimeter of said lens; the image-side surface of the second lens is convex; the image-side surface of the third lens is concave, the object-side surface and the image-side surface of the fourth lens are both concave at the optical axis; the object-side surface of the fifth lens is concave at the perimeter of said lens; and the image-side surface of the sixth lens is concave at the optical axis.

### CROSS REFERENCE TO RELATED APPLICATION

This application claims priority to Chinese Patent Applications No. 2018111816967, filed on Oct. 11, 2018.

### TECHNICAL FIELD

The present disclosure relates to an optical imaging technology, and in particular, to an optical lens group, an imaging module and an electronic device.

### BACKGROUND

In order to meet technical requirements of ultra-high pixels and higher optical transfer function (MTF), a current six-element optical lens group generally has a relatively long total length, which will limit the miniaturization, lightness, and thinness of electronic products. Therefore, there is an urgent need for an optical lens group with good image quality and miniaturization.

### SUMMARY

According to various embodiments, an optical lens group, an imaging module, and an electronic device are provided.

An optical lens group includes, successively in order from an object side to an image side:

a first lens having a positive refractive power, an object side surface of the first lens being concave at a circumference thereof, an image side surface of the first lens being convex at the circumference thereof;

a second lens having a positive refractive power, an image side surface of the second lens being convex;

a third lens having a negative refractive power, an image side surface of the third lens being concave;

a fourth lens having a negative refractive power, an object side surface and an image side surface of the fourth lens being concave at an optical axis;

a fifth lens having a positive refractive power, an object side surface of the fifth lens being concave at a circumference thereof, the object side surface and an image side surface of the fifth lens being aspherical, the object side surface of the fifth lens being provided with at least one inflection point;

a sixth lens having a negative refractive power, an image side of the sixth lens being concave at the optical axis, an object side surface and the image side surface of the sixth lens being aspherical, at least one of the object side surface and the image side surface of the sixth lens being provided with at least one inflection point.

The optical lens group satisfies the following condition:

0.7<f/f1<1.0;

Where f is a focal length of the optical lens group, and f1 is a focal length of the first lens.

An imaging module includes:

the optical lens group as described above; and

a photosensitive element provided on an image side of the optical lens group.

An electronic device includes:

a housing; and

the imaging module as described above. The imaging module is mounted on the housing.

The details of one or more embodiments of the present disclosure are set forth in the following drawings and description. Other features, objects and advantages of the present disclosure will become apparent from the description, drawings, and claims.

### BRIEF DESCRIPTION OF THE DRAWINGS

In order to better describe and illustrate embodiments and/or examples of these disclosures disclosed herein, reference may be made to one or more drawings. Additional details or examples used to describe the drawings should not be considered as a limitation on the scope of any of the disclosed disclosures, the currently described embodiments and/or examples, and the best modes of these disclosures currently understood.

FIG. 1 is a structural schematic view of an optical lens group according to a first embodiment of the present application.

FIG. 2 is a graph showing spherical aberration (mm), astigmatism (mm), and distortion (%) of the optical lens group according to the first embodiment.

FIG. 3 is a structural schematic view of an optical lens group according to a second embodiment of the present application.

FIG. 4 is a graph showing spherical aberration (mm), astigmatism (mm), and distortion (%) of the optical lens group according to the second embodiment.

FIG. 5 is a structural schematic view of an optical lens group according to a third embodiment of the present application.

FIG. 6 is a graph showing spherical aberration (mm), astigmatism (mm), and distortion (%) of the optical lens group according to the third embodiment.

FIG. 7 is a structural schematic view of an optical lens group according to a fourth embodiment of the present application.

FIG. 8 is a graph showing spherical aberration (mm), astigmatism (mm), and distortion (%) of the optical lens group according to the fourth embodiment.

FIG. 9 is a structural schematic view of an optical lens group according to a fifth embodiment of the present application.

FIG. 10 is a graph showing spherical aberration (mm), astigmatism (mm), and distortion (%) of the optical lens group according to the fifth embodiment.

FIG. 11 is a structural schematic view of an imaging module according to an embodiment of the present disclosure.

FIG. 12 is a structural schematic view of an electronic device according to an embodiment of the present disclosure.

### DETAILED DESCRIPTION OF THE EMBODIMENTS

In order to facilitate the understanding of the present disclosure, the present disclosure will be described more fully below with reference to the relevant drawings. Preferred embodiments of the present disclosure are shown in the drawings. However, the present disclosure can be implemented in many different forms and is not limited to the embodiments described herein. On the contrary, providing these embodiments is to make the disclosure of the present disclosure more thorough and comprehensive.

It should be noted that when an element is referred to as being “fixed on” another element, it can be directly on another element or intervening elements may be present therebetween. When an element is referred to as being “connected” or “coupled” to another element, it can be directly connected or coupled to the other element or intervening elements may be present therebetween. Terms “inside”, “outside”, “left”, “right” and similar expressions used herein are for illustrative purposes only, and do not mean that they are the only embodiments.

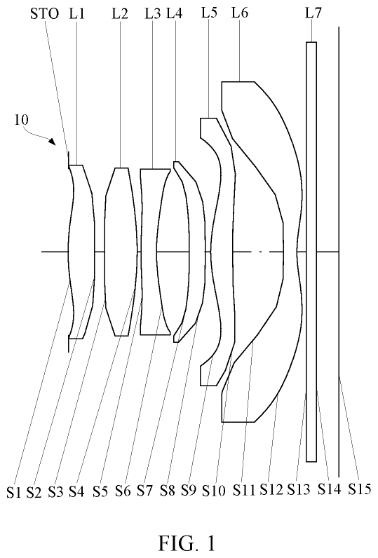

Referring to FIGS. 1, 3, 5, 7 and 9, an optical lens group according to an embodiment of the present disclosure includes a first lens having a positive refractive power, a second lens having a positive refractive power, a third lens having a negative refractive power, a fourth lens having a negative refractive power, a fifth lens having a positive refractive power, and a sixth lens having a negative refractive power that are successively arranged in order from an object side to an image side.

An optical lens group 10 according to an embodiment of the present disclosure includes a first lens L1 having a positive refractive power, a second lens L2 having a positive refractive power, a third lens L3 having a negative refractive power, a fourth lens L4 having a negative refractive power, a fifth lens L5 having a positive refractive power, and a sixth lens L6 having a negative refractive power that are successively arranged in order from an object side to an image side.

The first lens L1 has an object side surface S1 and an image side surface S2. The object side surface S1 is concave at a circumference thereof. The image side surface S2 is convex at the circumference thereof. The second lens L2 has an object side surface S3 and an image side surface S4. The image side surface S4 is convex. The third lens L3 has an object side surface S5 and an image side surface S6. The image side surface S6 is concave. The fourth lens L4 has an object side surface S7 and an image side surface S8. Both the object side surface S7 and the image side surface S8 are concave at an optical axis. The fifth lens L5 has an object side surface S9 and an image side surface S10. The object side surface S9 is concave at the circumference thereof. Both the object side surface S9 and the image side surface S10 are aspherical. The object side surface S9 is provided with at least one inflection point. For example, the object side surface S9 includes one, two or three inflection points. The sixth lens L6 includes an object side surface S11 and an image side surface S12. The image side surface S12 is concave at the optical axis. Both the object side surface S11 and the image side surface S12 are aspherical. At least one surface of the object side surface S11 and the image side surface S12 is provided with at least one inflection point. For example, the object side surface S11 includes one, two, or three inflection points. For another example, the image side surface S12 includes one, two, or three inflection points. For another example, the object side surface S11 includes one, two, or three inflection points. Moreover, the image side surface S12 further includes one, two or three inflection points. In other embodiments, the number of inflection points is not limited to the above-mentioned one, two or three, and can also be others such as five, six, etc. In addition, the optical lens group 10 further includes an imaging surface S15. The imaging surface S15 may be a photosensitive surface of a photosensitive element.

It should be noted that when describing that a side surface of the lens is convex at the optical axis (at a central area of the side surface), it can be understood that an area of the side surface of the lens adjacent to the optical axis is convex, and thus it can also be understood that the side surface adjacent to the optical surface is convex. When describing that a side surface of the lens is concave at a circumference thereof, it can be understood that the area adjacent to the maximum effective radius of the side surface is concave. For example, when the side surface is convex at the optical axis and also convex at the circumference, a shape of the side surface in a direction from a center (an optical axis) to an edge can be a pure convex surface; or can be a convex shape at the center, and then transitioned to a concave shape, and then become a convex surface when approaching the maximum effective radius. This is only an example to illustrate the relationship between a shape and a structure of the side surface at the optical axis and at the circumference, the various shapes, and structures (concave-convex relationship) of the side surface are not fully illustrated, but other situations can be derived from the above examples.

When the configuration of the refractive power and the conditions of the surface shape of the lenses as described above are satisfied, the optical lens group 10 can be designed to be miniaturized.

The optical lens group 10 satisfies the following condition: 0.7<f/f1<1.0; where f is a focal length of the optical lens group 10, and f1 is a focal length of the first lens L1. In other words, f/f1 can be any value in an interval (0.7, 1.0). For example, the value may be 0.729, 0.805, 0.810, 0.839, 0.864, 0.914, 0.966, and so on.

The optical lens group 10 according to the embodiments of the present disclosure can achieve excellent imaging quality while ensuring the miniaturization of the optical lens group 10. When the optical lens group 10 satisfies the condition 0.74/f1<1.0, the refractive power of the first lens L1 is reasonably configured, which can effectively shorten the total optical length of the optical lens group 10 and prevent a high-order spherical aberration of the optical lens group 10 from being excessively increased, thereby improving the imaging quality. The optical lens group 10 according to the embodiments of the present disclosure can achieve excellent imaging quality while ensuring the miniaturization of the optical lens group.

In some embodiments, the optical lens group 10 satisfies the following condition: 0.3<R7/R6<0.6; where R7 is a radius of curvature of the image side surface S6 of the third lens L3 at the optical axis, and R6 is a radius of curvature of the object side surface S5 of the third lens L3 at the optical axis. In other words, R7/R6 can be any value in an interval (0.3, 0.6). For example, the value may be 0.327, 0.345, 0.398, 0.416, 0.447, 0.498, 0.545, and so on.

When the optical lens group 10 satisfies the condition 0.3<R7/R6<0.6, the refractive power of the third lens L3 may not be too large, and the spherical aberration of the optical lens group 10 can be corrected while the sensitivity of the optical lens group 10 can be reduced. Therefore, it is beneficial to improve the yield of the optical lens group 10.

In some embodiments, the optical lens group 10 satisfies the following condition: R7/f>0.5; where R7 is a radius of curvature of the image side surface S6 of the third lens L3 at the optical axis. In other words, R7/f can be any value greater than 0.5. For example, the value may be 0.57, 0.60, 0.62, 0.63, 0.67, 0.78, 0.89, and so on.

When the optical lens group 10 satisfies the condition R7/f>0.5, an aberration generated by the optical lens group 10 can be corrected, while an excessive back focal length of the optical lens group 10 can be avoided, which is beneficial to shorten the total optical length of the optical lens group 10, and improve the imaging quality of the optical lens group 10.

In some embodiments, the optical lens group 10 satisfies the following condition: 2<|f/f5|+|f/f6|<3; where f5 is a focal length of the fifth lens L5, and f6 is a focal length of the sixth lens L6. In other words, |f/f5|+|f/f6|can be any value in an interval (2, 3). For example, the value may be 2.219, 2.359, 2.462, 2.588, 2.635, 2.756, 2.889, and so on.

When the optical lens group 10 satisfies the condition 2<|f/f5|+|f/f6|<3, it can have a good compensation effect on the spherical aberration and astigmatism generated by the optical lens group 10, thereby improving the imaging quality of the optical lens group 10.

In some embodiments, the optical lens group 10 satisfies the following condition: TTL/ImgH≤1.5; where TTL is a distance from the object side surface S1 of the first lens L1 to the imaging surface S15 on the optical axis, and ImgH is a maximum imaging height of the optical lens group 10. In other words, ImgH/TTL can be any value less than or equal to 1.5. For example, the value may be 0.964, 1.231, 1.393, 1.415, 1.447, 1.462, 1.487, 1.500, and so on.

When the optical lens group 10 satisfies the condition TTL/ImgH≤1.5, the user's demand for high pixels of the optical lens group 10 and the demand for miniaturization of the optical lens group 10 can both be met.

In some embodiments, the optical lens group 10 satisfies the following condition: (CT1+CT2)/TTL<0.3; where CT1 is a central thickness of the first lens L1 on the optical axis, CT2 is a central thickness of the second lens L2 on the optical axis, and TTL is a distance from the object side surface S1 of the first lens L1 to the imaging surface S15 on the optical axis. In other words, (CT1+CT2)/TTL can be any value less than 0.3. For example, the value may be 0.199, 0.203, 0.206, 0.210, 0.218, 0.245, 0.289 and so on.

When the optical lens group 10 satisfies the condition (CT1+CT2)/TTL<0.3, the optical lens group 10 is configured with reasonable thicknesses of the first lens L1 and the second lens L2, which is beneficial to reduce the sensitivity of the optical lens group 10, and shorten the total optical length of the optical lens group 10 simultaneously.

In some embodiments, the optical lens group 10 satisfies the following condition: 0.9<R7/R1<1.0; where R7 is a radius of curvature of the image side surface S5 of the third lens L3, and R1 is a radius of curvature of the object side surface S1 of the first lens L1. In other words, R7/R1 can be any value in an interval (0.9, 1). For example, the value may be 0.914, 0.926, 0.943, 0.946, 0.956, 0.964, 0.985, and so on.

When the optical lens group 10 satisfies the condition 0.9<R7/R1<1.0, excessive aberration of the optical lens group 10 can be avoided, the sensitivity of the optical lens group 10 can be reduced, and the imaging quality of the optical lens group 10 can be improved.

In some embodiments, the optical lens group 10 satisfies the following condition: 0.6<(CT5+CT6)/T56<1; where CT5 is a central thickness of the fifth lens L5 on the optical axis, CT6 is a center thickness of the sixth lens L6 the optical axis, and T56 is a distance between the fifth lens L5 and the sixth lens L6 on the optical axis. In other words, (CT5+CT6)/T56 can be any value in an interval (0.6, 1). For example, the value may be 0.697, 0.703, 0.766, 0.845, 0.898, 0.953, 0.988, and so on.

When the optical lens group 10 satisfies the condition 0.6<(CT5+CT6)/T56<1, it is beneficial to reduce the sensitivity of the optical lens group 10, improve the imaging quality of the optical lens group 10, and shorten the total optical length of the optical lens group 10 simultaneously.

In some embodiments, the optical lens group 10 further includes a filter. The filter is provided between the sixth lens L6 and the imaging surface S15. In the embodiments of the present disclosure, the filter is an infrared filter L7. The infrared filter L7 includes an object side surface S13 and an image side surface S14. The infrared filter L7 is an infrared cut-off filter, which can be used to filter out infrared light and prevent the infrared light from reaching the imaging surface S15. When the optical lens group 10 is used for imaging, light emitted or reflected by a subject to be imaged enters the optical lens group 10 from the object side, passes through the first lens L1, the second lens L2, the third lens L3, the fourth lens L4, the fifth lens L5, the sixth lens L6, the object side surface S13 and the image side surface S14 of the infrared filter L7 sequentially, and is finally converged on the imaging surface S15. In some embodiments, the infrared filter L7 is part of the optical lens group 10. In other embodiments, the optical lens group 10 may not be provided with the infrared filter L7. The infrared filter L7 can be assembled with a photosensitive element and assembled on the image side of the infrared filter L7 together with the photosensitive element, or the infrared filter L7 can also be directly provided in the infrared filter L7 to be integrated with each lens.

A diaphragm (STO) may be an aperture diaphragm or a field diaphragm. Embodiments of the present disclosure will be described with an example in which the diaphragm STO is the aperture diaphragm. The diaphragm STO can be provided between the first lens L1 and the subject to be imaged, or on a surface of any lens, or between any two lenses, or between the sixth lens L6 and the infrared filter L7. In the embodiments of the present disclosure, the diaphragm STO is provided on the object side surface S1 of the first lens L1, which can better control the amount of light entering and improve the imaging effect. It should be noted that in the embodiments of the present application, when describing that the diaphragm STO is provided on the object side of the first lens L1, or describing that the optical lens group 10 is sequentially provided with the diaphragm STO, the first lens L1, the second lens L2 and the like from the object side to the image side, a projection of the diaphragm STO on the optical axis of the first lens L1 may overlap, or may not overlap with a projection of the first lens L1 on the optical axis.

In some embodiments, the first lens L1 to the sixth lens L6 are plastic lenses or glass lenses. In a first embodiment to a fifth embodiment of the embodiments of the present disclosure, the first lens L1 to the sixth lens L6 are all plastic lenses. As such, the optical lens group 10 can achieve ultra-thinness while correcting aberrations and solving the temperature drift problem through a reasonable configuration of the lens materials, and the cost is low.

When each lens in the optical lens group 10 is made of plastic, the plastic lens can reduce the weight of the optical lens group 10 and reduce the production cost. In other embodiments, each lens in the optical lens group 10 is made of glass. In this case, the optical lens group 10 can withstand higher temperatures and has better optical performance. In other embodiments, the first lens L1 is made of glass, and the other lenses are made of plastic. In this case, the first lens L1 closest to the object side can well withstand the influence of the environmental temperature on the object side. Due to the fact that the other lenses are made of plastic, the optical lens group 10 can further maintain a low production cost. It should be noted that, according to actual requirements, each lens in the optical lens group 10 can be made of any one of plastic or glass.

In some embodiments, at least one surface of the first lens L1 to the sixth lens L6 in the optical lens group 10 is aspherical. For example, in the first embodiment to the fifth embodiment, the object side surfaces and the image side surfaces of the first lens L1 to the sixth lens L6 are both aspherical. A shape of the aspheric surface is determined by the following equation:

$$Z = \frac{c {r}^{2}}{1 + \sqrt{1 - ( k + 1 ) {c}^{2} {r}^{2}}} + Σ A i {r}^{i} ;$$

where Z is a longitudinal distance between any point on the aspheric surface and a surface vertex, r is a distance from any point on the aspheric surface to the optical axis, c is a curvature of the vertex (a reciprocal of the radius of curvature), k is a conic constant, and Ai is a correction coefficient of the i^{th} order of the aspheric surface.

As such, the optical lens group 10 can effectively reduce the total length of the optical lens group 10, and can effectively correct aberrations and improve the imaging quality, by adjusting the radiuses of curvature and aspheric coefficients of each lens surface.

### First Embodiment

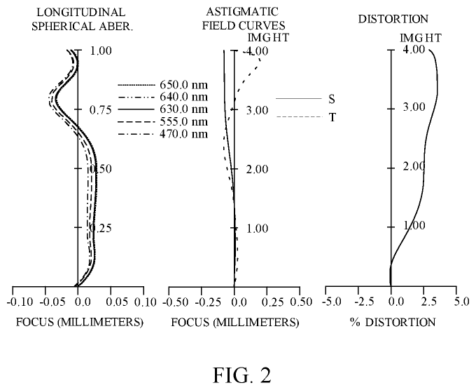

Referring to FIGS. 1 and 2, from an object side to an image side, an optical lens group 10 according to the first embodiment includes a diaphragm STO, a first lens L1, a second lens L2, a third lens L3, a fourth lens L4, a fifth lens L5, a sixth lens L6, and an infrared filter L7 that are successively arranged. Reference wavelengths of an astigmatism diagram and a distortion diagram in each of the embodiments are 630 nm.

The first lens L1 has a positive refractive power and is made of plastic. An object side surface S1 of the first lens L1 is convex at an optical axis and concave at a circumference thereof. An image side surface S2 of the first lens L1 is concave at the optical axis and convex at the circumference. Both the object side surface S1 and the image side surface S2 are aspherical.

The second lens L2 has a positive refractive power and is made of plastic. An object side surface S3 of the second lens L2 is concave at the optical axis and convex at the circumference thereof. An image side surface S4 of the second lens L2 is convex. Both the object side surface S3 and the image side surface S4 are aspherical.

The third lens L3 has a negative refractive power and is made of plastic. An object side surface S5 of the third lens L3 is convex. An image side surface S6 of the third lens L3 is concave. Both the object side surface S5 and the image side surface S6 are aspherical.

The fourth lens L4 has a negative refractive power and is made of plastic. An object side surface S7 of the fourth lens L4 is concave. An image side surface S8 of the fourth lens L4 is concave at the optical axis and convex at the circumference thereof. Both the object side surface S7 and the image side surface S8 are aspherical.

The fifth lens L5 has a positive refractive power and is made of plastic. An object side surface S9 of the fifth lens L5 is convex at the optical axis and concave at the circumference thereof. An image side surface S10 of the fifth lens L5 is concave at the optical axis and convex at the circumference. Both the object side surface S9 and the image side surface 510 are aspherical.

The sixth lens L6 has a negative refractive power and is made of plastic. An object side surface S11 of the sixth lens L6 is convex at the optical axis and concave at the circumference thereof. An image side surface S12 of the sixth lens L6 is concave at the optical axis and convex at the circumference. Both the object side surface S11 and the image side surface S12 are aspherical.

The infrared filter L7 is made of glass, and is provided between the sixth lens L6 and the imaging surface S15, which does not affect a focal length of the optical lens group 10.

In this embodiment, light passing through the optical lens group 10 is d-line. That is, the light has a wavelength of 587.6 nanometers (nm).

In the first embodiment, the focal length of the optical lens group 10 is f=4.63 mm. The number of apertures of the optical lens group 10 is FNO=1.5. A diagonal viewing angle of the optical lens group 10 is FOV=80.00 degrees. A distance from the object side surface S1 of the first lens L1 to the imaging surface S15 on the optical axis is TTL=5.66 mm. The optical lens group 10 further satisfies the following conditions: f/f1=0.805; R7/R6=0.416; R7/f=0.63; |f/f5|+|f/f6|=2.359; TTL/ImgH=1.415; (CT1+CT2)/TTL=0.218; R7/R1=0.943; (CT5+CT6)/T56=0.697.

Various parameters of the optical lens group 10 are shown in Table 1 and Table 2. The elements of the optical lens group 10 from the object surface (object side) to the imaging surface S15 are sequentially arranged in the order of the elements in Table 1 from top to bottom. Surface numbers 2 and 3 in Table 1 are the object side surface S1 and the image side surface S2 of the first lens L1 respectively. That is, in the same lens, the surface with a smaller surface number is the object side surface, and the surface with a larger surface number is the image side surface. A Y radius is a radius of curvature of the object side surface or image side surface of the corresponding surface number at the optical axis (or understood as being at a paraxial position). In a “thickness” parameter column of the first lens L1, a first value is a thickness of this lens on the optical axis, a second value is a distance from the image side surface of the lens to the object side of the latter lens on the optical axis. A value corresponding to a surface number 15 in the “thickness” parameter of the infrared filter L7 is a distance from the image side surface S14 of the infrared filter L7 to the imaging surface S15. K in Table 2 is a conic constant. Ai is a correction coefficient of the i^{th} order of an aspheric surface. Generally, the imaging surface S15 in Table 1 is a photosensitive surface of a photosensitive element.

In addition, values of a refractive index and the focal length of each lens are obtained at the reference wavelength of 630 nm. The calculation of the relation, and the surface shape of the lens are based on the lens parameters (such as the data in Table 1) and the aspheric coefficient (such as the data in Table 2).

The optical lens group 10 satisfies the conditions in the following tables.

TABLE 1
First Embodiment
f = 4.63 mm, FNO = 1.5, FOV = 80.00 degrees, TTL = 5.66 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | number | (mm) |
| 0 | Object to | Spherical | Infinite | Infinite | | | | |
| | be imaged | | | | | | | |
| 1 | diaphragm | Spherical | Infinite | −0.014 | | | | |
| 2 | First Lens | Aspherical | 3.093 | 0.554 | Plastic | 1.543 | 56.0 | 5.75 |
| 3 | | Aspherical | 429.308 | 0.210 | | | | |
| 4 | Second | Aspherical | −47.673 | 0.681 | Plastic | 1.535 | 55.8 | 8.89 |
| 5 | Lens | Aspherical | −4.331 | 0.080 | | | | |
| 6 | Third Lens | Aspherical | 7.017 | 0.324 | Plastic | 1.670 | 19.4 | −7.76 |
| 7 | | Aspherical | 2.918 | 0.688 | | | | |
| 8 | Fourth | Aspherical | −11.527 | 0.329 | Plastic | 1.607 | 26.6 | −11.18 |
| 9 | Lens | Aspherical | 16.465 | 0.118 | | | | |
| 10 | Fifth Lens | Aspherical | 2.192 | 0.459 | Plastic | 1.543 | 56.0 | 4.06 |
| 11 | | Aspherical | 433.514 | 1.061 | | | | |
| 12 | Sixth Lens | Aspherical | 117.634 | 0.281 | Plastic | 1.535 | 55.8 | −3.80 |
| 13 | | Aspherical | 1.990 | 0.198 | | | | |
| 14 | Infrared | Spherical | Infinite | 0.210 | Glass | 1.517 | 64.2 | |
| 15 | Filter | Spherical | Infinite | 0.467 | | | | |
| 16 | Imaging | Spherical | Infinite | 0.000 | | | | |
| | Surface | | | | | | | |

TABLE 2
First Embodiment
Aspheric Coefficient

| Surface Number | 2 | 3 | 4 | 5 | 6 | 7 |
|---|---|---|---|---|---|---|
| K | 4.0328E−02 | 0.0000E+00 | 0.0000E+00 | −1.1550E−01 | −7.4022E−01 | −2.1851E−02 |
| A3 | −6.0002E−03 | −2.5311E−03 | −1.2966E−02 | 3.1609E−03 | −4.6291E−03 | −1.5097E−02 |
| A4 | −2.3792E−02 | −2.6223E−02 | 1.1406E−01 | 8.9678E−02 | 1.0543E−02 | 2.0616E−03 |
| A5 | 4.5782E−02 | −5.3844E−02 | −3.6576E−01 | −1.3198E−01 | −2.0590E−01 | −3.7561E−01 |
| A6 | −2.6806E−01 | 1.0402E−01 | 8.3087E−01 | 1.0715E−01 | 3.1643E−01 | 9.7915E−01 |
| A7 | 4.9654E−01 | −1.3504E−01 | −1.1043E+00 | −6.5221E−02 | −2.9589E−01 | −1.3304E+00 |
| A8 | −4.9557E−01 | 9.8353E−02 | 8.8390E−01 | 3.4302E−02 | 1.5834E−01 | 1.0393E+00 |
| A9 | 2.4058E−01 | −3.5586E−02 | −3.7893E−01 | −1.4357E−02 | −3.2926E−02 | −4.3353E−01 |
| A10 | −4.3989E−02 | 5.2689E−03 | 6.5675E−02 | 3.2427E−03 | 1.9005E−04 | 7.6463E−02 |
| A11 | 0.0000E+00 | 0.0000E+00 | 0.0000E+00 | 0.0000E+00 | 0.0000E+00 | 0.0000E+00 |
| A12 | 0.0000E+00 | 0.0000E+00 | 0.0000E+00 | 0.0000E+00 | 0.0000E+00 | 0.0000E+00 |
| A13 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A15 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+00 |
| Surface Number | 8 | 9 | 10 | 11 | 12 | 13 |
| K | −6.1226E+00 | 2.4805E+01 | −4.3320E−01 | 0.0000E+00 | 0.0000E+00 | −1.5285E+01 |
| A3 | 3.4932E−03 | 3.5158E−03 | −1.0316E−02 | 1.1558E−03 | 2.5164E−01 | 2.1392E−01 |
| A4 | −4.0200E−02 | −1.6481E−01 | −8.3969E−02 | 6.8749E−02 | −1.1534E+00 | −7.0312E−01 |
| A5 | 4.3975E−05 | −9.5489E−06 | 1.0648E−03 | 3.2480E−05 | 1.5367E+00 | 8.0179E−01 |
| A6 | 3.2421E−02 | 8.3288E−02 | 2.6126E−02 | −5.2349E−02 | −1.3432E+00 | −5.4855E−01 |
| A7 | 1.7082E−05 | −1.5666E−04 | −3.6350E−05 | 4.7297E−06 | 7.8147E−01 | 2.3657E−01 |
| A8 | −3.2714E−02 | −3.1251E−02 | −1.3566E−02 | 1.7861E−02 | −2.7758E−01 | −6.1072E−02 |
| A9 | −1.0607E−06 | −6.3504E−05 | −4.9020E−05 | 1.4431E−06 | 5.4561E−02 | 8.4136E−03 |
| A10 | 1.6619E−02 | 7.1980E−04 | 4.6478E−03 | −3.4053E−03 | −4.5991E−03 | −4.6580E−04 |
| A11 | 2.0795E−06 | −1.5931E−05 | −4.6805E−06 | −1.9580E−07 | 0.0000E+00 | 0.0000E+00 |
| A12 | −5.8032E−03 | 4.2678E−03 | −1.0884E−03 | 2.0738E−04 | 0.0000E+00 | 0.0000E+00 |
| A13 | 5.1159E−06 | −2.0565E−06 | 2.3771E−07 | 1.0858E−08 | 0.0000E+00 | 0.0000E+00 |
| A14 | 8.6931E−04 | −1.7727E−03 | 1.2444E−04 | 2.6650E−05 | 0.0000E+00 | 0.0000E+00 |
| A15 | 4.1828E−06 | 5.2445E−07 | 1.9957E−07 | −6.7467E−09 | 0.0000E+00 | 0.0000E+00 |
| A16 | −1.2351E−05 | 2.3564E−04 | −4.2791E−06 | −3.1939E−06 | 0.0000E+00 | 0.0000E+00 |

### Second Embodiment

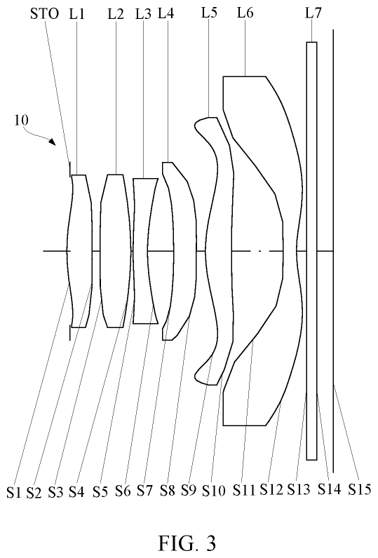

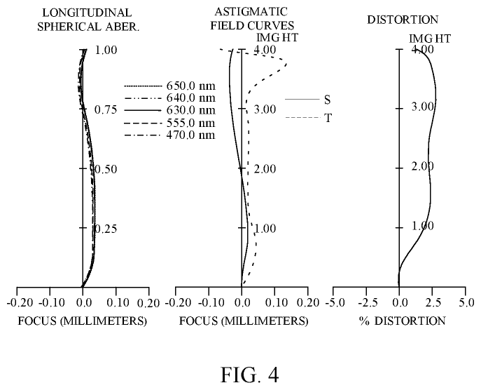

Referring to FIGS. 3 and 4, from an object side to an image side, an optical lens group 10 according to the second embodiment includes a diaphragm STO, a first lens L1, a second lens L2, a third lens L3, a fourth lens L4, a fifth lens L5, a sixth lens L6, and an infrared filter L7 that are successively arranged.

The first lens L1 has a positive refractive power and is made of plastic. An object side surface S1 of the first lens L1 is convex at an optical axis and concave at a circumference thereof. An image side surface S2 of the first lens L1 is concave at the optical axis and convex at the circumference. Both the object side surface S1 and the image side surface S2 are aspherical. The second lens L2 has a positive refractive power and is made of plastic. An object side surface S3 of the second lens L2 is concave at the optical axis and convex at the circumference thereof. An image side surface S4 of the second lens L2 is convex. Both the object side surface S3 and the image side surface S4 are aspherical. The third lens L3 has a negative refractive power and is made of plastic. An object side surface S5 of the third lens L3 is convex at the optical axis, and is concave at the circumference thereof. An image side surface S6 of the third lens L3 is concave. Both the object side surface S5 and the image side surface S6 are aspherical. The fourth lens L4 has a negative refractive power and is made of plastic. An object side S7 of the fourth lens L4 is concave. An image side S8 of the fourth lens L4 is concave at the optical axis and convex at the circumference thereof. Both the object side surface S7 and the image side surface S8 are aspherical. The fifth lens L5 has a positive refractive power and is made of plastic. An object side surface S9 of the fifth lens L5 is convex at the optical axis and concave at the circumference thereof. An image side surface S10 of the fifth lens L5 is convex. Both the object side surface S9 and the image side surface 510 are aspherical. The sixth lens L6 has a negative refractive power and is made of plastic. An object side surface S11 of the sixth lens L6 is convex. An image side surface S12 of the sixth lens L6 is concave at the optical axis and convex at the circumference thereof. Both the object side surface S11 and the image side surface S12 are aspherical.

The infrared filter L7 is made of glass, and is provided between the sixth lens L6 and the imaging surface S15, which does not affect a focal length of the optical lens group 10.

In this embodiment, light passing through the optical lens group 10 is d-line. That is, the light has a wavelength of 630 nanometers (nm).

The optical lens group 10 satisfies the conditions in the following tables (the definition of each of parameters can be obtained from the first embodiment, and will not be repeated here).

TABLE 3
Second Embodiment
f = 4.31 mm; FNO = 1.6; FOV = 84.96 degrees, TTL = 5.57 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | Number | (mm) |
| 0 | Object to be | Spherical | Infinite | Infinite | | | | |
| | imaged | | | | | | | |
| 1 | diaphragm | Spherical | Infinite | −0.065 | | | | |
| 2 | First Lens | Aspherical | 3.018 | 0.528 | Plastic | 1.543 | 56.0 | 5.91 |
| 3 | | Aspherical | 49.271 | 0.168 | | | | |
| 4 | Second Lens | Aspherical | −98.055 | 0.640 | Plastic | 1.535 | 55.8 | 8.51 |
| 5 | | Aspherical | −4.343 | 0.048 | | | | |
| 6 | Third Lens | Aspherical | 6.462 | 0.300 | Plastic | 1.670 | 19.4 | −8.12 |
| 7 | | Aspherical | 2.887 | 0.547 | | | | |
| 8 | Fourth Lens | Aspherical | −12.030 | 0.474 | Plastic | 1.607 | 26.6 | −11.20 |
| 9 | | Aspherical | 15.676 | 0.192 | | | | |
| 10 | Fifth Lens | Aspherical | 2.145 | 0.546 | Plastic | 1.543 | 56.0 | 3.90 |
| 11 | | Aspherical | −121.996 | 1.078 | | | | |
| 12 | Sixth Lens | Aspherical | 135.718 | 0.280 | Plastic | 1.535 | 55.8 | −3.87 |
| 13 | | Aspherical | 2.028 | 0.214 | | | | |
| 14 | Infrared | Spherical | Infinite | 0.210 | Glass | 1.517 | 64.2 | |
| 15 | Filter | Spherical | Infinite | 0.347 | | | | |
| 16 | Imaging | Spherical | Infinite | 0.000 | | | | |
| | Surface | | | | | | | |

TABLE 4
Second Embodiment
Aspheric Coefficient

| Surface Number | 2 | 3 | 4 | 5 | 6 | 7 |
|---|---|---|---|---|---|---|
| K | 6.2891E−03 | −3.1874E+01 | −8.4531E+01 | 3.1406E−03 | 3.7648E−02 | −1.4567E−04 |
| A3 | −6.9749E−03 | −3.5300E−03 | −1.1632E−02 | 3.9272E−03 | −6.5802E−03 | −7.4138E−03 |
| A4 | −2.3316E−02 | −2.6559E−02 | 1.1468E−01 | 8.9443E−02 | 1.0744E−02 | 2.7801E−03 |
| A5 | 4.6034E−02 | −5.3462E−02 | −3.6575E−01 | −1.3216E−01 | −2.0572E−01 | −3.7568E−01 |
| A6 | −2.6800E−01 | 1.0446E−01 | 8.3078E−01 | 1.0704E−01 | 3.1652E−01 | 9.7905E−01 |
| A7 | 4.9654E−01 | −1.3478E−01 | −1.1043E+00 | −6.5279E−02 | −2.9583E−01 | −1.3305E+00 |
| A8 | −4.9558E−01 | 9.8448E−02 | 8.8388E−01 | 3.4280E−02 | 1.5836E−01 | 1.0392E+00 |
| A9 | 2.4058E−01 | −3.5595E−02 | −3.7894E−01 | −1.4347E−02 | −3.2912E−02 | −4.3362E−01 |
| A10 | −4.3986E−02 | 5.2117E−03 | 6.5668E−02 | 3.2627E−03 | 1.8979E−04 | 7.6373E−02 |
| A11 | 0.0000E+00 | 0.0000E+00 | 0.0000E+00 | 0.0000E+00 | 0.0000E+00 | 0.0000E+00 |
| A12 | 0.0000E+00 | 0.0000E+00 | 0.0000E+00 | 0.0000E+00 | 0.0000E+00 | 0.0000E+00 |
| A13 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A15 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+00 |
| Surface Number | 8 | 9 | 10 | 11 | 12 | 13 |
| K | −2.0355E+00 | −2.7763E+00 | −4.3351E−01 | −9.6344E+01 | −1.5703E+01 | −1.1917E+01 |
| A3 | 2.9565E−04 | −1.8080E−04 | −3.3519E−04 | −1.7599E−05 | 2.5240E−01 | 2.1502E−01 |
| A4 | −4.1733E−02 | −1.6375E−01 | −8.4248E−02 | 6.9431E−02 | −1.1530E+00 | −7.0346E−01 |
| A5 | 6.8411E−05 | −5.8843E−05 | −8.8443E−05 | 1.8447E−05 | 1.5369E+00 | 8.0198E−01 |
| A6 | 3.3344E−02 | 8.3194E−02 | 2.6441E−02 | −5.2277E−02 | −1.3432E+00 | −5.4844E−01 |
| A7 | 1.0779E−05 | −1.9186E−05 | −9.2737E−06 | 5.7827E−06 | 7.8147E−01 | 2.3660E−01 |
| A8 | −3.2518E−02 | −3.1174E−02 | −1.3541E−02 | 1.7883E−02 | −2.7758E−01 | −6.1066E−02 |
| A9 | −2.1151E−06 | −4.2739E−06 | −1.2659E−06 | 1.2970E−06 | 5.4559E−02 | 8.4133E−03 |
| A10 | 1.6601E−02 | 7.7739E−04 | 4.6452E−03 | −3.4041E−03 | −4.5990E−03 | −4.6641E−04 |
| A11 | −3.4103E−06 | −1.6564E−07 | −2.9553E−07 | 2.5098E−07 | 0.0000E+00 | 0.0000E+00 |
| A12 | −5.8332E−03 | 4.2837E−03 | −1.0881E−03 | 2.0757E−04 | 0.0000E+00 | 0.0000E+00 |
| A13 | 0.0000E+00 | 0.0000E+00 | 0.0000E+00 | 0.0000E+00 | 0.0000E+00 | 0.0000E+00 |
| A14 | 8.5419E−04 | −1.7710E−03 | 1.2467E−04 | 2.6641E−05 | 0.0000E+00 | 0.0000E+00 |
| A15 | 0.0000E+00 | 0.0000E+00 | 0.0000E+00 | 0.0000E+00 | 0.0000E+00 | 0.0000E+00 |
| A16 | −1.7668E−05 | 2.3462E−04 | −4.1746E−06 | −3.1998E−06 | 0.0000E+00 | 0.0000E+00 |

According to Table 3 and Table 4, the following data can be obtained.

| | | | |
|---|---|---|---|
| F (mm) | 4.31 | R7/f | 0.67 |
| FNO | 1.6 | \|f/f5\| +\|f/f6\| | 2.219 |
| FOV (degree) | 84.96 | TTL/ImgH | 1.393 |
| TTL (mm) | 5.57 | (CT1 + CT2)/TTL | 0.210 |
| f/f1 | 0.729 | R7/R1 | 0.956 |
| R7/R6 | 0.447 | (CT5 + CT6)/T56 | 0.766 |

### Third Embodiment

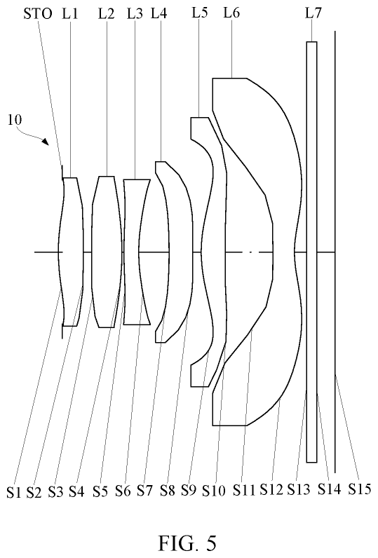

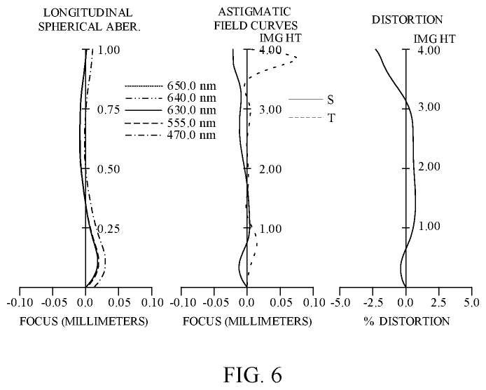

Referring to FIGS. 5 and 6, from an object side to an image side, an optical lens group 10 according to the third embodiment includes a diaphragm STO, a first lens L1, a second lens L2, a third lens L3, a fourth lens L4, a fifth lens L5, a sixth lens L6, and an infrared filter L7 that are successively arranged.

The first lens L1 has a positive refractive power and is made of plastic. An object side surface S1 of the first lens L1 is convex at the optical axis and concave at the circumference thereof. An image side surface S2 of the first lens L1 is concave at the optical axis and convex at the circumference. Both the object side surface S1 and the image side surface S2 are aspherical. The second lens L2 has a positive refractive power and is made of plastic. An object side surface S3 of the second lens L2 is convex. An image side surface S4 of the second lens L2 is convex. Both the object side surface S3 and the image side surface S4 are aspherical. The third lens L3 has a negative refractive power and is made of plastic. An object side surface S5 of the third lens L3 is convex at the optical axis and concave at the circumference thereof. An image side surface S6 of the third lens L3 is concave. Both the object side surface S5 and the image side surface S6 are aspherical. The fourth lens L4 has a negative refractive power and is made of plastic. An object side surface S7 of the fourth lens L4 is concave. An image side surface S8 of the fourth lens L4 is concave at the optical axis and convex at the circumference thereof. Both the object side surface S7 and the image side surface S8 are aspherical. The fifth lens L5 has positive refractive power and is made of plastic. An object side surface S9 of the fifth lens L5 is convex at the optical axis and concave at the circumference thereof. An image side surface S10 of the fifth lens L5 is convex. Both the object side surface S9 and the image side surface S10 are aspherical. The sixth lens L6 has a negative refractive power and is made of plastic. An object side surface S11 of the sixth lens L6 is convex. An image side surface S12 of the sixth lens L6 is concave at the optical axis and convex at the circumference thereof. Both the object side surface S11 and the image side surface S12 are aspherical.

The infrared filter L7 is made of glass, and is provided between the sixth lens L6 and the imaging surface S15, which does not affect a focal length of the optical lens group 10.

In this embodiment, light passing through the optical lens group 10 is d-line. That is, the light has a wavelength of 630 nanometers (nm).

The optical lens group 10 satisfies the conditions in the following tables (the definition of each of parameters can be obtained from the first embodiment, and will not be repeated here):

TABLE 5
Third Embodiment
f = 4.70 mm; FNO = 1.8; FOV = 82.07 degrees; TTL = 5.79 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | Number | (mm) |
| 0 | Object to be | Spherical | Infinite | Infinite | | | | |
| | imaged | | | | | | | |
| 1 | diaphragm | Spherical | Infinite | −0.080 | | | | |
| 2 | First Lens | Aspherical | 3.066 | 0.519 | Plastic | 1.543 | 56.0 | 5.80 |
| 3 | | Aspherical | 116.640 | 0.176 | | | | |
| 4 | Second Lens | Aspherical | 802.659 | 0.633 | Plastic | 1.535 | 55.8 | 7.76 |
| 5 | | Aspherical | −4.154 | 0.042 | | | | |
| 6 | Third Lens | Aspherical | 6.759 | 0.310 | Plastic | 1.670 | 19.4 | −6.94 |
| 7 | | Aspherical | 2.692 | 0.634 | | | | |
| 8 | Fourth Lens | Aspherical | −10.919 | 0.492 | Plastic | 1.607 | 26.6 | −8.83 |
| 9 | | Aspherical | 10.581 | 0.180 | | | | |
| 10 | Fifth Lens | Aspherical | 2.054 | 0.502 | Plastic | 1.543 | 56.0 | 3.74 |
| 11 | | Aspherical | −138.569 | 0.999 | | | | |
| 12 | Sixth Lens | Aspherical | 81.615 | 0.450 | Plastic | 1.535 | 55.8 | −3.41 |
| 13 | | Aspherical | 1.772 | 0.254 | | | | |
| 14 | Infrared | Spherical | Infinite | 0.210 | Glass | 1.517 | 64.2 | |
| 15 | Filter | Spherical | Infinite | 0.388 | | | | |
| 16 | Imaging | Spherical | Infinite | 0.000 | | | | |
| | Surface | | | | | | | |

TABLE 6
Third Embodiment
Aspheric Coefficient

| Surface Number | 2 | 3 | 4 | 5 | 6 | 7 |
|---|---|---|---|---|---|---|
| K | −8.3952E−03 | 8.9266E+01 | 3.0594E+01 | −2.2795E−02 | −1.2144E+00 | −1.2501E−02 |
| A3 | −6.2437E−03 | −2.8418E−03 | −1.1501E−02 | 2.7513E−03 | −5.5930E−03 | −8.8449E−03 |
| A4 | −2.3426E−02 | −2.6459E−02 | 1.1427E−01 | 8.9491E−02 | 1.0241E−02 | 2.7288E−03 |
| A5 | 4.6073E−02 | −5.3550E−02 | −3.6591E−01 | −1.3217E−01 | −2.0598E−01 | −3.7574E−01 |
| A6 | −2.6796E−01 | 1.0443E−01 | 8.3072E−01 | 1.0704E−01 | 3.1642E−01 | 9.7901E−01 |
| A7 | 4.9652E−01 | −1.3476E−01 | −1.1044E+00 | −6.5232E−02 | −2.9586E−01 | −1.3305E+00 |
| A8 | −4.9565E−01 | 9.8443E−02 | 8.8385E−01 | 3.4354E−02 | 1.5837E−01 | 1.0392E+00 |
| A9 | 2.4049E−01 | −3.5677E−02 | −3.7894E−01 | −1.4273E−02 | −3.2886E−02 | −4.3364E−01 |
| A10 | −4.4072E−02 | 5.0312E−03 | 6.5726E−02 | 3.3141E−03 | 2.2571E−04 | 7.6354E−02 |
| A11 | 0.0000E+00 | 0.0000E+00 | 0.0000E+00 | 0.0000E+00 | 0.0000E+00 | 0.0000E+00 |
| A12 | 0.0000E+00 | 0.0000E+00 | 0.0000E+00 | 0.0000E+00 | 0.0000E+00 | 0.0000E+00 |
| A13 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A15 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+00 |
| Surface Number | 8 | 9 | 10 | 11 | 12 | 13 |
| K | 1.1491E+01 | −5.5874E+01 | −5.9456E−01 | 6.8773E+01 | 1.5965E+01 | −1.1401E+01 |
| A3 | −9.3772E−04 | −3.9658E−03 | −1.6068E−03 | −3.2089E−03 | −1.1530E+00 | −7.0661E−01 |
| A4 | −4.2567E−02 | −1.6566E−01 | −8.5696E−02 | 6.8833E−02 | 1.5369E+00 | 8.0160E−01 |
| A5 | 1.3030E−03 | −6.5603E−04 | −6.8536E−04 | −2.3616E−05 | −1.3432E+00 | −5.4846E−01 |
| A6 | 3.4008E−02 | 8.3540E−02 | 2.6191E−02 | −5.2263E−02 | 7.8147E−01 | 2.3658E−01 |
| A7 | 5.4652E−05 | 2.7901E−04 | 1.8985E−04 | 1.3979E−05 | −2.7758E−01 | −6.1076E−02 |
| A8 | −3.2714E−02 | −3.1065E−02 | −1.3522E−02 | 1.7886E−02 | 5.4560E−02 | 8.4097E−03 |
| A9 | −1.9708E−04 | −3.0531E−06 | −7.0200E−06 | 2.9273E−06 | −4.6015E−03 | −4.6775E−04 |
| A10 | 1.6477E−02 | 7.4404E−04 | 4.6345E−03 | −3.4034E−03 | 0.0000E+00 | 0.0000E+00 |
| A11 | −6.5458E−05 | −3.3010E−05 | −9.4443E−06 | 5.5205E−07 | 0.0000E+00 | 0.0000E+00 |
| A12 | −5.8575E−03 | 4.2612E−03 | −1.0940E−03 | 2.0769E−04 | 0.0000E+00 | 0.0000E+00 |
| A13 | 0.0000E+00 | 0.0000E+00 | 0.0000E+00 | 0.0000E+00 | 0.0000E+00 | 0.0000E+00 |
| A14 | 8.5668E−04 | −1.7776E−03 | 1.2305E−04 | 2.6655E−05 | 0.0000E+00 | 0.0000E+00 |
| A15 | 0.0000E+00 | 0.0000E+00 | 0.0000E+00 | 0.0000E+00 | 0.0000E+00 | 0.0000E+00 |
| A16 | −1.2884E−05 | 2.3339E−04 | −4.5008E−06 | −3.1984E−06 | 0.0000E+00 | 0.0000E+00 |

According to Table 5 and Table 6, the following data can be obtained.

| | | | |
|---|---|---|---|
| F (mm) | 4.70 | R7/f | 0.57 |
| FNO | 1.8 | \|f/f5\| +\|f/f6\| | 2.635 |
| FOV (degree) | 82.07 | TTL/ImgH | 1.447 |
| TTL (mm) | 5.79 | (CT1 + CT2)/TTL | 0.199 |
| f/f1 | 0.810 | R7/R1 | 0.878 |
| R7/R6 | 0.398 | (CT5 + CT6)/T56 | 0.953 |

### Fourth Embodiment

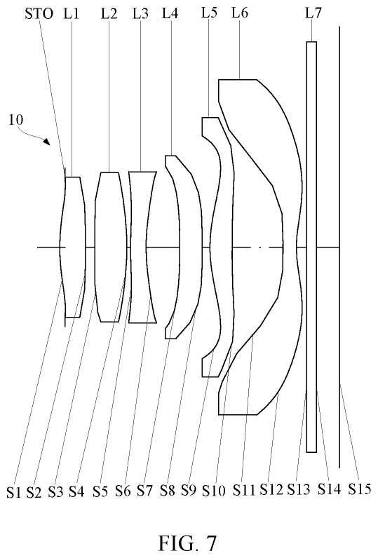

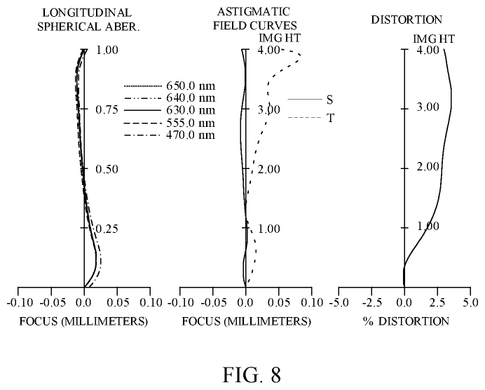

Referring to FIGS. 7 and 8, from an object side to an image side, an optical lens group 10 according to the fourth embodiment includes a diaphragm STO, a first lens L1, a second lens L2, a third lens L3, a fourth lens L4, a fifth lens L5, a sixth lens L6, and an infrared filter L7 that are successively arranged.

The first lens L1 has a positive refractive power and is made of plastic. An object side surface S1 of the first lens L1 is convex at the optical axis and concave at the circumference thereof. An image side surface S2 of the first lens L1 is convex. Both the object side surface S1 and the image side surface S2 are aspherical. The second lens L2 has a positive refractive power and is made of plastic. An object side surface S3 of the second lens L2 is concave at the optical axis and convex at the circumference thereof. Both the object side surface S3 and the image side surface S4 are aspherical. The third lens L3 has a negative refractive power and is made of plastic. An object side surface S5 of the third lens L3 is convex at the optical axis and concave at the circumference thereof. An image side surface S6 of the third lens L3 is concave. Both the object side surface S5 and the image side surface S6 are aspherical. The fourth lens L4 has a negative refractive power and is made of plastic. An object side surface S7 of the fourth lens L4 is concave. An image side surface S8 of the fourth lens L4 is concave at the optical axis and convex at the circumference thereof. Both the object side surface S7 and the image side surface S8 are aspherical. The fifth lens L5 has a positive refractive power and is made of plastic. An object side surface S9 of the fifth lens L5 is convex at the optical axis and concave at the circumference thereof. An image side surface S10 of the fifth lens L5 is convex. Both the object side surface S9 and the image side surface S10 are aspherical. The sixth lens L6 has a negative refractive power and is made of plastic. An object side surface S11 of the sixth lens L6 is convex. An image side surface S12 of the sixth lens L6 is concave at the optical axis and convex at the circumference thereof. Both the object side surface S11 and the image side surface S12 are aspherical.

The infrared filter L7 is made of glass, and is provided between the sixth lens L6 and the imaging surface S15, which does not affect a focal length of the optical lens group 10.

In this embodiment, light passing through the optical lens group 10 is d-line. That is, the light has a wavelength of 630 nanometers (nm).

The optical lens group 10 satisfies the conditions in the following tables (the definition of each of parameters can be obtained from the first embodiment, and will not be repeated here).

TABLE 7
Fourth Embodiment
f = 4.78 mm; FNO = 2.0; FOV = 78.12 degrees; TTL = 5.85 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | Number | (mm) |
| 0 | Object to be | Spherical | Infinite | Infinite | | | | |
| | imaged | | | | | | | |
| 1 | diaphragm | Spherical | Infinite | −0.108 | | | | |
| 2 | First Lens | Aspherical | 3.126 | 0.536 | Plastic | 1.543 | 56.0 | 5.70 |
| 3 | | Aspherical | −235.286 | 0.198 | | | | |
| 4 | Second Lens | Aspherical | −44.890 | 0.668 | Plastic | 1.535 | 55.8 | 8.20 |
| 5 | | Aspherical | −4.003 | 0.080 | | | | |
| 6 | Third Lens | Aspherical | 8.564 | 0.323 | Plastic | 1.670 | 19.4 | −6.95 |
| 7 | | Aspherical | 2.957 | 0.705 | | | | |
| 8 | Fourth Lens | Aspherical | −10.733 | 0.464 | Plastic | 1.607 | 26.6 | −10.33 |
| 9 | | Aspherical | 15.127 | 0.167 | | | | |
| 10 | Fifth Lens | Aspherical | 2.201 | 0.465 | Plastic | 1.543 | 56.0 | 3.98 |
| 11 | | Aspherical | −107.002 | 1.062 | | | | |
| 12 | Sixth Lens | Aspherical | 195.561 | 0.282 | Plastic | 1.535 | 55.8 | −3.79 |
| 13 | | Aspherical | 1.996 | 0.211 | | | | |
| 14 | Infrared | Spherical | Infinite | 0.210 | Glass | 1.517 | 64.2 | |
| 15 | Filter | Spherical | Infinite | 0.480 | | | | |
| 16 | Imaging | Spherical | Infinite | 0.000 | | | | |
| | Surface | | | | | | | |

TABLE 8
Fourth Embodiment
Aspheric Coefficient

| Surface Number | 2 | 3 | 4 | 5 | 6 | 7 |
|---|---|---|---|---|---|---|
| K | 3.9736E−02 | 1.5574E+00 | 7.7897E+01 | −2.7142E−01 | −1.7209E+00 | −6.7299E−02 |
| A3 | −5.9045E−03 | −3.8456E−03 | −1.1921E−02 | 3.8738E−03 | −6.0050E−03 | −1.2047E−02 |
| A4 | −2.3860E−02 | −2.6063E−02 | 1.1402E−01 | 9.0050E−02 | 1.0262E−02 | 2.1626E−03 |
| A5 | 4.5902E−02 | −5.3396E−02 | −3.6587E−01 | −1.3199E−01 | −2.0580E−01 | −3.7622E−01 |
| A6 | −2.6791E−01 | 1.0443E−01 | 8.3083E−01 | 1.0705E−01 | 3.1655E−01 | 9.7870E−01 |
| A7 | 4.9667E−01 | −1.3475E−01 | −1.1043E+00 | −6.5314E−02 | −2.9582E−01 | −1.3306E+00 |
| A8 | −4.9549E−01 | 9.8510E−02 | 8.8392E−01 | 3.4244E−02 | 1.5837E−01 | 1.0392E+00 |
| A9 | 2.4064E−01 | −3.5536E−02 | −3.7891E−01 | −1.4384E−02 | −3.2920E−02 | −4.3359E−01 |
| A10 | −4.3955E−02 | 5.2411E−03 | 6.5684E−02 | 3.2372E−03 | 1.8347E−04 | 7.6437E−02 |
| A11 | 0.0000E+00 | 0.0000E+00 | 0.0000E+00 | 0.0000E+00 | 0.0000E+00 | 0.0000E+00 |
| A12 | 0.0000E+00 | 0.0000E+00 | 0.0000E+00 | 0.0000E+00 | 0.0000E+00 | 0.0000E+00 |
| A13 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A15 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+00 |
| Surface Number | 8 | 9 | 10 | 11 | 12 | 13 |
| K | 1.0772E+01 | 2.0133E+01 | −4.2703E−01 | −1.2685E+01 | −1.0218E+00 | −1.3613E+01 |
| A3 | 4.1432E−03 | −1.5170E−03 | −5.0962E−03 | 6.4579E−04 | 2.5153E−01 | 2.1712E−01 |
| A4 | −4.2313E−02 | −1.6517E−01 | −8.3830E−02 | 6.8744E−02 | −1.1534E+00 | −7.0281E−01 |
| A5 | −5.6278E−04 | 5.1206E−04 | 7.8081E−04 | −3.5816E−05 | 1.5368E+00 | 8.0171E−01 |
| A6 | 3.2464E−02 | 8.3655E−02 | 2.5929E−02 | −5.2357E−02 | −1.3432E+00 | −5.4856E−01 |
| A7 | 1.6829E−04 | 5.8869E−05 | −1.8588E−04 | 6.6367E−06 | 7.8147E−01 | 2.3656E−01 |
| A8 | −3.2604E−02 | −3.1132E−02 | −1.3545E−02 | 1.7863E−02 | −2.7758E−01 | −6.1075E−02 |
| A9 | 5.4999E−05 | −1.6567E−06 | −1.6745E−06 | 2.3162E−06 | 5.4561E−02 | 8.4119E−03 |
| A10 | 1.6640E−02 | 7.5512E−04 | 4.6726E−03 | −3.4049E−03 | −4.5998E−03 | −4.6645E−04 |
| A11 | 5.5816E−06 | 9.4977E−07 | 1.9194E−06 | 3.4562E−08 | 0.0000E+00 | 0.0000E+00 |
| A12 | −5.8063E−03 | 4.2766E−03 | −1.0889E−03 | 2.0764E−04 | 0.0000E+00 | 0.0000E+00 |
| A13 | 6.7312E−07 | 2.5260E−06 | −1.5487E−06 | 6.6581E−08 | 0.0000E+00 | 0.0000E+00 |
| A14 | 8.6546E−04 | −1.7702E−03 | 1.2308E−04 | 2.6687E−05 | 0.0000E+00 | 0.0000E+00 |
| A15 | 1.3809E−06 | 1.9244E−06 | −5.5086E−07 | 5.0391E−09 | 0.0000E+00 | 0.0000E+00 |
| A16 | −1.4231E−05 | 2.3629E−04 | −4.6346E−06 | −3.1883E−06 | 0.0000E+00 | 0.0000E+00 |

According to Table 7 and Table 8, the following data can be obtained.

| | | | |
|---|---|---|---|
| F (mm) | 4.78 | R7/f | 0.62 |
| FNO | 2.0 | \|f/f5\| +\|f/f6\| | 2.462 |
| FOV (degree) | 78.12 | TTL/ImgH | 1.462 |
| TTL (mm) | 5.85 | (CT1 + CT2)/TTL | 0.206 |
| f/f1 | 0.839 | R7/R1 | 0.946 |
| R7/R6 | 0.345 | (CT5 + CT6)/T56 | 0.703 |

### Fifth Embodiment

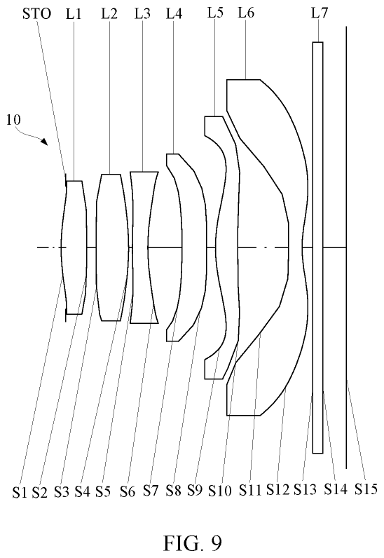

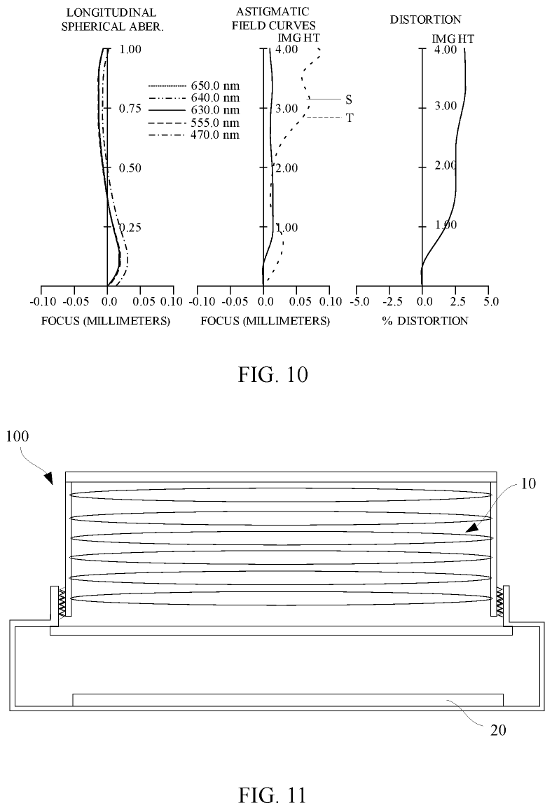

Referring to FIGS. 9 and 10, from an object side to an image side, an optical lens group 10 according to the fifth embodiment includes a diaphragm STO, a first lens L1, a second lens L2, a third lens L3, a fourth lens L4, a fifth lens L5, a sixth lens L6, and an infrared filter L7 that are successively arranged.

The first lens L1 has a positive refractive power and is made of plastic. An object side surface S1 of the first lens L1 is convex at the optical axis and concave at the circumference thereof. An image side surface S2 of the first lens L1 is convex. Both the object side surface S1 and the image side surface S2 are aspherical. The second lens L2 has a positive refractive power and is made of plastic. An object side surface S3 of is concave at the optical axis and convex at the circumference thereof. An image side surface S4 of the second lens L2 is convex. Both the object side surface S3 and the image side surface S4 are aspherical. The third lens L3 has a negative refractive power and is made of plastic. An object side surface S5 of the third lens L3 is convex at the optical axis and concave at the circumference thereof. An image side surface S6 of the third lens L3 is concave. Both the object side surface S5 and the image side surface S6 are aspherical. The fourth lens L4 has a negative refractive power and is made of plastic. An object side surface S7 of the fourth lens L4 is concave. An image side surface S8 of the fourth lens L4 is concave at the optical axis and convex at the circumference thereof. Both the object side surface S7 and the image side surface S8 are aspherical. The fifth lens L5 has a positive refractive power and is made of plastic. An object side surface S9 of the fifth lens L5 is convex at the optical axis and concave at the circumference thereof. An image side surface S10 of the fifth lens L5 is convex. Both the object side surface S9 and the image side surface S10 are aspherical. The sixth lens L6 has a negative refractive power and is made of plastic. An object side surface S11 of the sixth lens L6 is convex. An image side surface S12 of the sixth lens L6 is concave at the optical axis and convex at the circumference thereof. Both the object side surface S11 and the image side surface S12 are aspherical.

The infrared filter L7 is made of glass, and is provided between the sixth lens L6 and the imaging surface S15, which does not affect a focal length of the optical lens group 10.

In this embodiment, light passing through the optical lens group 10 is d-line. That is, the light has a wavelength of 630 nanometers (nm).

The optical lens group 10 satisfies the conditions in the following tables (the definition of each of parameters can be obtained from the first embodiment, and will not be repeated here).

TABLE 9
Fifth Embodiment
f = 4.91 mm; FNO = 2.2; FOV = 76.58 degrees; TTL = 5.95 mm

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | Number | (mm) |
| 0 | Object to be | Spherical | Infinite | Infinite | | | | |
| | imaged | | | | | | | |
| 1 | diaphragm | Spherical | Infinite | −0.096 | | | | |
| 2 | First | Aspherical | 3.178 | 0.534 | Plastic | 1.543 | 56.0 | 5.68 |
| 3 | Lens | Aspherical | −91.137 | 0.199 | | | | |
| 4 | Second | Aspherical | −44.955 | 0.674 | Plastic | 1.535 | 55.8 | 8.03 |
| 5 | Lens | Aspherical | −3.925 | 0.080 | | | | |
| 6 | Third | Aspherical | 9.002 | 0.322 | Plastic | 1.670 | 19.4 | −6.72 |
| 7 | Lens | Aspherical | 2.944 | 0.715 | | | | |
| 8 | Fourth | Aspherical | −10.586 | 0.510 | Plastic | 1.607 | 26.6 | −9.89 |
| 9 | Lens | Aspherical | 13.951 | 0.188 | | | | |
| 10 | Fifth | Aspherical | 2.186 | 0.466 | Plastic | 1.543 | 56.0 | 3.95 |
| 11 | Lens | Aspherical | −99.258 | 1.062 | | | | |
| 12 | Sixth | Aspherical | 240.260 | 0.281 | Plastic | 1.535 | 55.8 | −3.65 |
| 13 | Lens | Aspherical | 1.930 | 0.221 | | | | |
| 14 | Infrared | Spherical | Infinite | 0.210 | Glass | 1.517 | 64.2 | |
| 15 | Filter | Spherical | Infinite | 0.490 | | | | |
| 16 | Imaging | Spherical | Infinite | 0.000 | | | | |
| | Surface | | | | | | | |

TABLE 10
Fifth Embodiment
Aspheric Coefficient

| Surface Number | 2 | 3 | 4 | 5 | 6 | 7 |
|---|---|---|---|---|---|---|
| K | 3.0764E−02 | 1.0692E+01 | 9.5070E+01 | −3.0183E−01 | −1.6357E+00 | −7.7777E−02 |
| A3 | −5.7923E−03 | −3.9901E−03 | −1.1538E−02 | 3.7033E−03 | −5.8039E−03 | −1.1689E−02 |
| A4 | −2.3932E−02 | −2.5969E−02 | 1.1399E−01 | 9.0122E−02 | 1.0280E−02 | 2.1620E−03 |
| A5 | 4.5913E−02 | −5.3315E−02 | −3.6592E−01 | −1.3195E−01 | −2.0578E−01 | −3.7631E−01 |
| A6 | −2.6788E−01 | 1.0448E−01 | 8.3081E−01 | 1.0706E−01 | 3.1656E−01 | 9.7862E−01 |
| A7 | 4.9669E−01 | −1.3473E−01 | −1.1043E+00 | −6.5306E−02 | −2.9581E−01 | −1.3307E+00 |
| A8 | −4.9548E−01 | 9.8509E−02 | 8.8392E−01 | 3.4253E−02 | 1.5837E−01 | 1.0391E+00 |
| A9 | 2.4063E−01 | −3.5557E−02 | −3.7892E−01 | −1.4375E−02 | −3.2917E−02 | −4.3362E−01 |
| A10 | −4.3964E−02 | 5.2072E−03 | 6.5678E−02 | 3.2468E−03 | 1.8532E−04 | 7.6413E−02 |
| A11 | 0.0000E+00 | 0.0000E+00 | 0.0000E+00 | 0.0000E+00 | 0.0000E+00 | 0.0000E+00 |
| A12 | 0.0000E+00 | 0.0000E+00 | 0.0000E+00 | 0.0000E+00 | 0.0000E+00 | 0.0000E+00 |
| A13 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A15 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+00 |
| Surface Number | 8 | 9 | 10 | 11 | 12 | 13 |
| K | 1.2033E+01 | 2.0096E+01 | −4.4401E−01 | −3.7027E+01 | −5.0652E+01 | −1.2579E+01 |
| A3 | 3.3395E−03 | −9.1758E−04 | −5.2951E−03 | 7.5039E−04 | 2.5157E−01 | 2.1548E−01 |
| A4 | −4.2571E−02 | −1.6519E−01 | −8.4062E−02 | 6.8666E−02 | −1.1534E+00 | −7.0369E−01 |
| A5 | −3.3234E−04 | 1.9848E−04 | 7.3598E−04 | −7.3794E−05 | 1.5367E+00 | 8.0156E−01 |
| A6 | 3.2572E−02 | 8.3510E−02 | 2.5865E−02 | −5.2366E−02 | −1.3432E+00 | −5.4853E−01 |
| A7 | 1.3975E−04 | 4.2432E−05 | −2.3934E−04 | 3.5990E−06 | 7.8147E−01 | 2.3657E−01 |
| A8 | −3.2668E−02 | −3.1104E−02 | −1.3567E−02 | 1.7861E−02 | −2.7758E−01 | −6.1073E−02 |
| A9 | −1.8467E−06 | 2.5122E−05 | −4.9445E−06 | 1.5386E−06 | 5.4560E−02 | 8.4125E−03 |
| A10 | 1.6603E−02 | 7.7325E−04 | 4.6744E−03 | −3.4052E−03 | −4.5999E−03 | −4.6634E−04 |
| A11 | −1.3525E−05 | 1.0962E−05 | 3.3394E−06 | −4.5416E−08 | 0.0000E+00 | 0.0000E+00 |
| A12 | −5.8132E−03 | 4.2814E−03 | −1.0885E−03 | 2.0763E−04 | 0.0000E+00 | 0.0000E+00 |
| A13 | 6.1002E−07 | 4.3341E−06 | −1.6491E−06 | 7.0705E−08 | 0.0000E+00 | 0.0000E+00 |
| A14 | 8.6860E−04 | −1.7698E−03 | 1.2288E−04 | 2.6693E−05 | 0.0000E+00 | 0.0000E+00 |
| A15 | 5.4995E−06 | 1.7805E−06 | −7.1714E−07 | 8.5292E−09 | 0.0000E+00 | 0.0000E+00 |
| A16 | −1.0220E−05 | 2.3598E−04 | −4.7409E−06 | −3.1865E−06 | 0.0000E+00 | 0.0000E+00 |

According to Table 9 and Table 10, the following data can be obtained.

| | | | |
|---|---|---|---|
| F (mm) | 4.91 | R7/f | 0.60 |
| FNO | 2.2 | \|f/f5\| +\|f/f6\| | 2.588 |
| FOV (degree) | 76.58 | TTL/ImgH | 1.487 |
| TTL (mm) | 5.95 | (CT1 + CT2)/TTL | 0.203 |
| f/f1 | 0.864 | R7/R1 | 0.926 |
| R7/R6 | 0.327 | (CT5 + CT6)/T56 | 0.703 |

Referring to FIG. 11, an imaging module 100 in some embodiments of the present disclosure includes the optical lens group 10 according to any of the above embodiments and a photosensitive element 20. The photosensitive element 20 is provided on the image side of the optical lens group 10.

Specifically, the photosensitive element 20 may be a complementary metal oxide semiconductor (CMOS) image sensor or a charge-coupled device (CCD) image sensor.

The imaging module 100 according to the embodiments of the present disclosure can achieve excellent imaging quality while ensuring the miniaturization of the optical lens group 10. When the optical lens group 10 satisfies a condition 0.7<f/f1<1.0, the refractive power of the first lens is reasonably configured, which can effectively shorten the total optical length of the optical lens group 10, while the high-order spherical aberration of the optical lens group 10 can be prevented from being excessively increased, thereby improving the imaging quality.

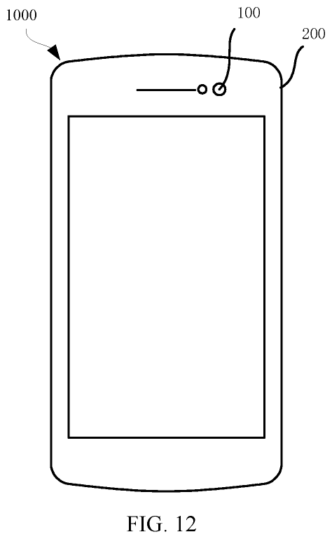

Referring to FIGS. 11 and 12, an electronic device 1000 includes a housing 200 and the imaging module 100 according to the above-mentioned embodiments. The imaging module 100 is mounted on the housing 200 to capture images.

The electronic device 1000 according to the embodiments of the present disclosure can obtain excellent imaging quality while ensuring the miniaturization of the optical lens group 10. When the optical lens group 10 satisfies the condition 0.7<f/f1<1.0, the refractive power of the first lens is reasonably configured, which can effectively shorten the total optical length of the optical lens group 10, while the high-order spherical aberration of the optical lens group 10 can be prevented from being excessively increased, thereby improving the imaging quality. In addition, the housing 200 can protect the imaging module 100.

The electronic device 1000 according to the embodiments of the present disclosure includes, but is not limited to, information terminal devices, such as smart phones, smart watches, tablet computers, notebook computers, personal computers (PCs), e-book readers, portable multimedia players (PMPs), portable phones, video phones, cameras, digital still cameras, game consoles, mobile medical devices, smart watches, wearable devices, home appliances with camera functions, or the like.

The “electronic device” used in the embodiments of the present disclosure may include, but is not limited to, a device configured to be connected via a wired line (such as via a public switched telephone network (PSTN), a digital subscriber line, (DSL), a digital cable, a direct cable connection, and/or another data connection/network) and/or via a wireless interface (of, for example, cellular network broadcast transmitters, wireless local area network (WLAN) broadcast transmitters, such as digital video broadcasting handheld (DVB-H) network digital TV network, satellite network, amplitude modulation-frequency modulation (AM-FM) broadcast transmitter, and/or another communication terminal) to receive/transmit communication signals. An electronic device configured to communicate through a wireless interface may be referred to as a “wireless communication terminal”, a “wireless terminal” and/or a “mobile terminal”. Examples of the mobile terminal include, but are not limited to satellites or cellular phones; personal communication system (PCS) terminals that can combine cellular radio phones with data processing, fax, and data communication capabilities; personal digital assistants (PDAs) that can include a radio phone, a pager, an internet/intranet access, a web browser, a memo pad, a calendar, and/or a global positioning system (GPS) receiver; and conventional laptop and/or palmtop receivers; or other electronic devices including a radio telephone transceiver.

In the description of the present disclosure, it should be understood that orientation or positional relationship indicated by terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, and the like are based on the orientation or positional relationship shown in the drawings, which are only for the convenience of describing the present disclosure and simplifying the description, rather than indicating or implying the indicated device or element must have a specific orientation, be constructed and operated in a specific orientation, and therefore cannot be understood as a limitation of the present disclosure.

In addition, terms “first” and “second” are only used for descriptive purposes, and cannot be understood as indicating or implying relative importance or implicitly indicating the number of indicated technical features. Therefore, features defined with “first” and “second” may explicitly or implicitly include at least one of the features. In the description of the present disclosure, “plurality” means at least two, such as two, three, unless expressly defined otherwise.

In the present disclosure, unless otherwise clearly specified and limited, terms “mounted”, “coupled”, “connected”, “fixed” and the like should be understood in a broad sense, for example, which may be a fixed connection or a detachable connection, or may be an integration, or may be a mechanical connection or an electrical connection, or may be a direct connection or an indirect connection through an intermediate medium, or may be an internal communication of two elements or an interaction relationship between two elements, unless expressly defined otherwise. For those of ordinary skill in the art, the specific meaning of the above-mentioned terms in the present disclosure can be understood according to specific circumstances.

In the present disclosure, unless expressly specified and defined otherwise, a first feature being “on” or “under” a second feature may mean that the first feature is in direct contact with the second feature, or that the first feature is in indirect contact with the second feature through an intermediate medium. Moreover, the first feature being “above”, “on” and “upside” the second feature may mean that the first feature is directly above or obliquely above the second feature, or simply mean that the level of the first feature is higher than that of the second feature. The first feature being “below”, “under” and “beneath” the second feature may mean that the first feature is directly below or obliquely below the second feature, or simply mean that the level of the first feature is smaller than the second feature.

In the description of this specification, descriptions such as referring to terms “one embodiment”, “some embodiments”, “examples”, “specific examples”, or “some examples” and the like mean that specific features, structures, materials, or characteristics described in conjunction with the embodiment or example are included in at least one embodiment or example of the present disclosure. In this specification, schematic representations of the above terms do not necessarily refer to the same embodiment or example. Moreover, the described specific features, structures, materials, or characteristics can be combined in any one or more embodiments or examples in a suitable manner. In addition, those skilled in the art can combine the different embodiments or examples and the features of the different embodiments or examples described in this specification without contradicting each other.

The technical features of the above-mentioned embodiments can be combined arbitrarily. In order to simply the description, all possible combinations of the technical features in the above-mentioned embodiments are not described. However, as long as there is no contradiction in the combinations of these technical features, they should be considered to be fallen into the range described in the present specification.

Only several embodiments of the present application are illustrated in the above-mentioned embodiments, and the description thereof is relatively specific and detailed, but it should not be understood as a limitation on the scope of the present application. It should be noted that for those of ordinary skill in the art, without departing from the concept of the present application, several modifications and improvements can be made, which all fall within the protection scope of the present application. Therefore, the protection scope of the present application shall be subject to the appended claims.

What is claimed is:

1. An optical lens group, comprising, successively in order from an object side to an image side:
a first lens having a positive refractive power, an object side surface of the first lens being concave at a circumference thereof, an image side surface of the first lens being convex at the circumference thereof;
a second lens having a positive refractive power, an image side surface of the second lens being convex;
a third lens having a negative refractive power, an image side surface of the third lens being concave;
a fourth lens having a negative refractive power, an object side surface and an image side surface of the fourth lens being concave at an optical axis;
a fifth lens having a positive refractive power, an object side surface of the fifth lens being concave at a circumference thereof; and
a sixth lens having a negative refractive power, an image side of the sixth lens being concave at the optical axis;
wherein the optical lens group satisfies the following condition:
0.7<f/f1<1.0;
where f is a focal length of the optical lens group, and f1 is a focal length of the first lens.

2. The optical lens group according to claim 1, wherein the optical lens group further satisfies the following condition:
0.3<R7/R6<0.6;
where R7 is a radius of curvature of the image side surface of the third lens, and R6 is a radius of curvature of an object side surface of the third lens.

3. The optical lens group according to claim 1, wherein the optical lens group further satisfies the following condition:
R7/f>0.5;
where R7 is a radius of curvature of the image side surface of the third lens.

4. The optical lens group according to claim 1, wherein the optical lens group further satisfies the following condition:
2<|f/f5|+|f/f6|<3;
where f5 is a focal length of the fifth lens, and f6 is a focal length of the sixth lens.

5. The optical lens group according to claim 1, wherein the optical lens group further satisfies the following condition:
TTL/ImgH≤1.5;
where TTL is a distance from the object side surface of the first lens to an imaging surface on the optical axis, and ImgH is a maximum imaging height of the optical lens group.

6. The optical lens group according to claim 1, wherein the optical lens group further satisfies the following condition:
(CT1+CT2)/TTL<0.3;
where CT1 is a central thickness of the first lens on the optical axis, CT2 is a central thickness of the second lens on the optical axis, and TTL is a distance from the object side surface of the first lens to an imaging surface on the optical axis.

7. The optical lens group according to claim 1, wherein the optical lens group further satisfies the following condition:
0.878<R7/R1<1.0;
where R7 is a radius of curvature of the image side surface of the third lens, and R1 is a radius of curvature of the object side surface of the first lens.

8. The optical lens group according to claim 1, wherein the optical lens group further satisfies the following condition:
0.6<(CT5+CT6)/T56<1;
where CT5 is a central thickness of the fifth lens on the optical axis, CT6 is a center thickness of the sixth lens the optical axis, and T56 is a distance between the fifth lens and the sixth lens on the optical axis.

9. The optical lens group according to claim 1, wherein the object side surface and an image side surface of the fifth lens are aspherical.

10. The optical lens group according to claim 1, wherein the object side surface of the fifth lens has at least one inflection point.

11. The optical lens group according to claim 1, wherein an object side surface and the image side surface of the sixth lens are aspherical.

12. The optical lens group according to claim 1, wherein at least one of an object side surface and the image side surface of the sixth lens has an inflection point.

13. The optical lens group according to claim 1, further comprising a diaphragm provided on an object side of the first lens.

14. The optical lens group according to claim 13, wherein the diaphragm is provided on the object side surface of the first lens.

15. The optical lens group according to claim 1, wherein the first lens, the second lens, the third lens, the fourth lens, the fifth lens, and the sixth lens are made of plastic.

16. The optical lens group according to claim 1, further comprising an infrared filter configured to filter out infrared light, wherein the infrared filter is provided on an image side of the sixth lens.

17. An imaging module, comprising:
the optical lens group according to claim 1; and
a photosensitive element provided on an image side of the optical lens group.

18. An electronic device, comprising:
a housing; and
the imaging module according to claim 17,
wherein the imaging module is mounted on the housing.

19. The optical lens group according to claim 1, wherein the object side surface and an image side surface of the first lens and the second lens are aspherical.

20. The optical lens group according to claim 1, wherein the object side surface and an image side surface of the third lens and the fourth lens are aspherical.
